(19) United States
(12) Patent Application Publication
(10) Pub. No.: US 2009/0132306 A1
(43) Pub. Date: May 21, 2009

(54) CONFIDENCE RATING SYSTEM

(75) Inventor: Howard Lee Dierking, Duvall, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/941,988

(22) Filed: Nov. 19, 2007

(51) Int. Cl. G06Q 10/00

(52) U.S. Cl. 705/7; 705/1

(57) ABSTRACT

Various technologies and techniques are disclosed for matching employer job requirements. Job requirements are expressed as assertions, and candidate qualifications are expressed as proofs. A language syntax is provided that allows at least one assertion to be expressed. The language syntax has grammar for representing a skill, an object of the skill, and an environment in which the skill is performed. A process for generating and using a model of assertions and proofs is provided. Assertions are received from at least one employer. Proofs are received from at least one candidate. Assertions and proofs are brought together into a model using a bipartite graph. The model is used to calculate a confidence rating score for a candidate for a given job position. A feedback process is used to improve the model of assertions and proofs over time.

### BACKGROUND

People who are seeking jobs need ways to locate and contact employers that have open job positions, and employers with open job positions need ways to locate and contact people who are seeking jobs. Technology such as the Internet has greatly improved the employment matching process. For example, various web sites such as Monster.com allow both employers and candidates to add profiles, search for matches, and so on. Employers can enter or upload a job description and specify other job information such as salary information. Some employment matching sites allow employers to select one or more skills that are required for the job from a list of skills. The candidate can upload a resume, fill in other details such as educational background or industry certifications, and sometimes even upload sample work or other files that better explain the candidate's qualifications. Employers and candidates then search the respective listings based on search criteria to see try and locate a suitable match.

As industries have become more advanced and specialized, the number of different job types has increased, along with the number of varying skills that those jobs require. This makes it more difficult for employers to determine whether a candidate who has a certain college degree or industry certification to know whether or not that candidate's background is really suited for a given job position. For example, suppose there are two candidates named John and Mary. John has a professional web developer certification from MICROSOFT®, and Mary also has a professional web developer certification from MICROSOFT®. However, John's obtained his certification earlier than Mary under an older set of exam requirements, and the exams that John took are quite different. In fact, Mary is certified in newer technologies than John, and had to pass even more exams than John did for his original certification. Thus, although the certifications have the same title, the skills that John and Mary have been certified under are very different. This same issue can occur in other areas of job qualifications, such as with college degrees. A degree from one university may not be the same as a degree with the same name from another university. For these reasons, employers often have to make experienced guesses during the candidate screening process to locate suitable candidates for the position.

### SUMMARY

Various technologies and techniques are disclosed for locating matching employer job requirements. Job requirements are expressed as assertions, and candidate qualifications are expressed as proofs. A language syntax is provided that allows at least one assertion to be expressed. The language syntax has grammar for representing a skill that is needed by a candidate for a specific job position, grammar for representing an object of the skill that is used to perform the skill, and grammar for representing an environment in which the skill is performed.

In one implementation, a process for generating and using a model of assertions and proofs is provided. Assertions are received from at least one employer, the assertions representing job requirements for one or more open job positions. Proofs are received from at least one candidate, the proofs representing candidate qualifications. Assertions and proofs are brought together into a model using a bipartite graph. The model is used to calculate a confidence rating score for one or more candidates for one or more given job positions.

In one implementation, a feedback process is used to improve the model of assertions and proofs over time. The model of assertions and proofs is used to generate a confidence rating score for a candidate for a particular job. After the candidate has been hired for the particular job, receiving input that indicates how well the confidence rating score represented an actual success of the candidate in performing the particular job. The model is updated based upon the input and used in later confidence rating score calculations.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a confidence rating system of one implementation.

FIG. 2 is a diagrammatic view of a computer system of one implementation.

FIG. 3 is a diagrammatic view of a confidence rating application for one implementation of the system of FIG. 1.

FIG. 4 is a diagrammatic view of three dimensions contained in an assertion language syntax of one implementation.

FIG. 5 is an exemplary syntax for representing assertions using the three dimensions described in FIG. 4.

FIG. 6 is a process flow diagram for one implementation illustrating the stages involved in bringing assertions and proofs together into a model.

FIG. 7 is a diagrammatic view of a model showing assertions and proofs together in a bipartite graph.

FIG. 8 is a process flow diagram for one implementation illustrating the stages involved in performing a score generation process to output a confidence rating score for a candidate for a particular job.

FIG. 9 is a diagrammatic view illustrating how a confidence rating score is calculated for a hypothetical candidate based upon hypothetical assertions and proofs.

FIG. 10 is a process flow diagram for one implementation illustrating the stages involved in receiving feedback from employers and/or candidates and using artificial intelligence to adjust the model over time.

FIG. 11 is a process flow diagram for one implementation illustrating the stages involved in allowing an employer to make an employment decision for a given job upon analyzing confidence rating scores.

FIG. 12 is a simulated screen for one implementation that shows an exemplary user interface for allowing an employer to enter search criteria to find matches for a particular job.

FIG. 13 is a process flow diagram for one implementation illustrating the stages involved in allowing a candidate to select one or more jobs and see how his skills compare to the selected jobs based on his confidence rating score for the given job.

### DETAILED DESCRIPTION

The technologies and techniques herein may be described in the general context as an application that generates a confidence rating for how well a candidate matches a given job position, but the technologies and techniques also serve other purposes in addition to these. In one implementation, one or more of the techniques described herein can be implemented as features within a job position network, or from any other type of program or service that brings employer requirements and candidate qualifications together to help find matches for given job positions.

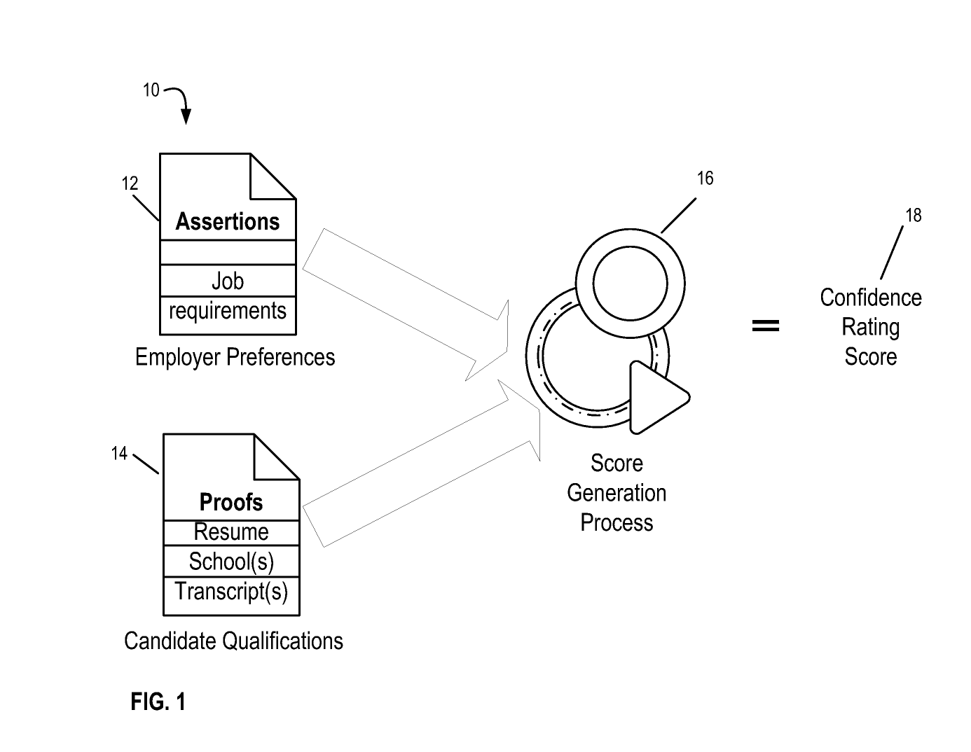

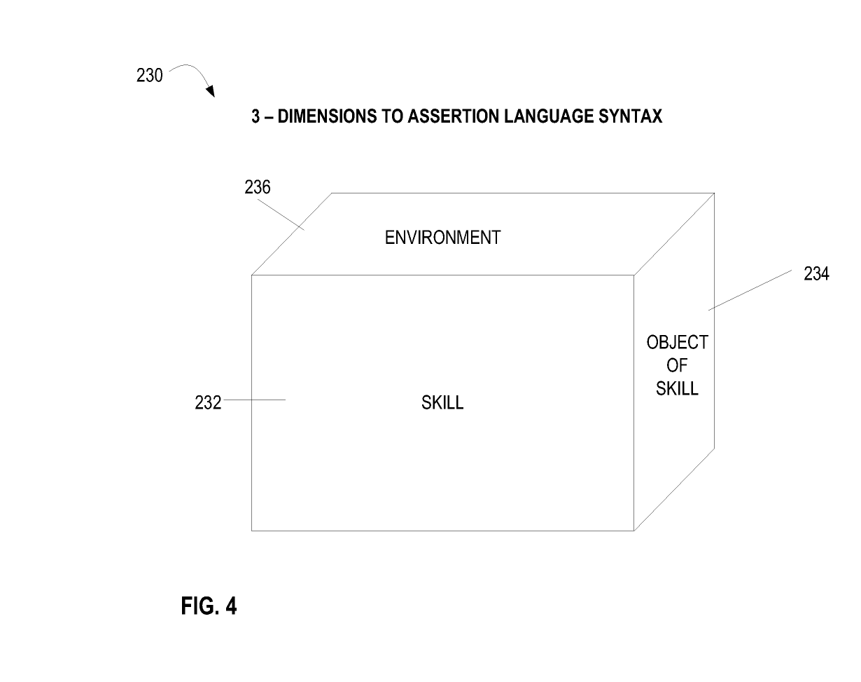

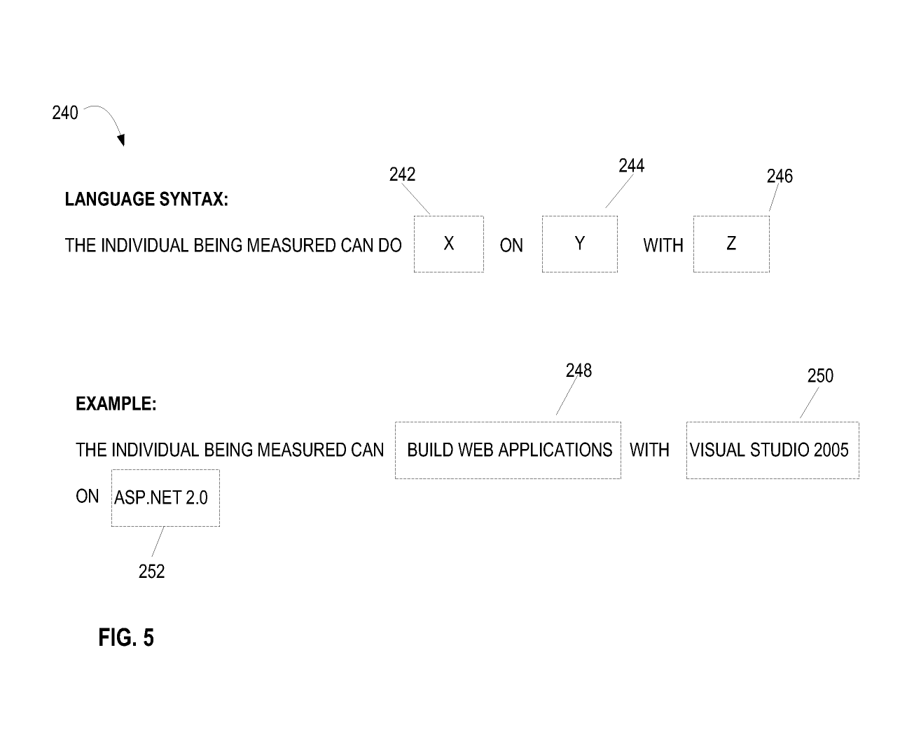

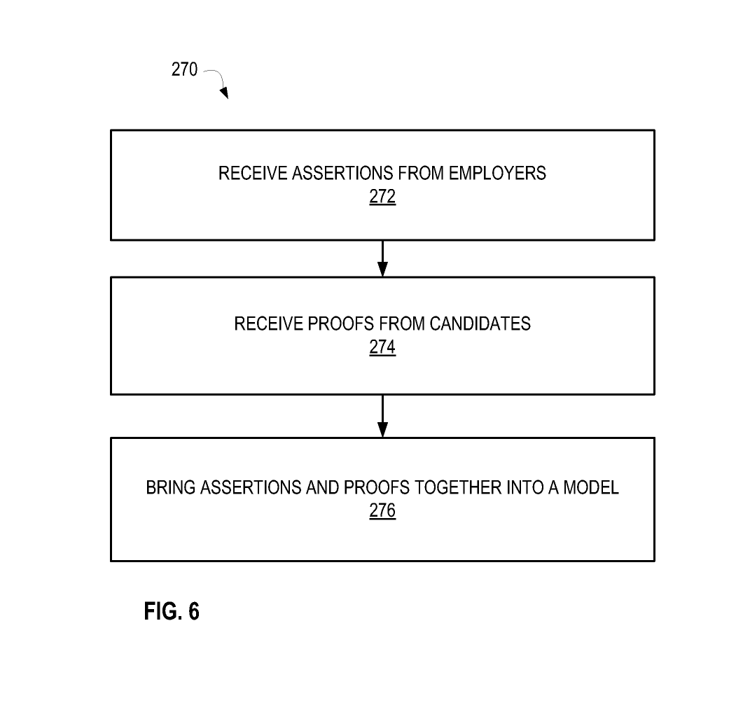

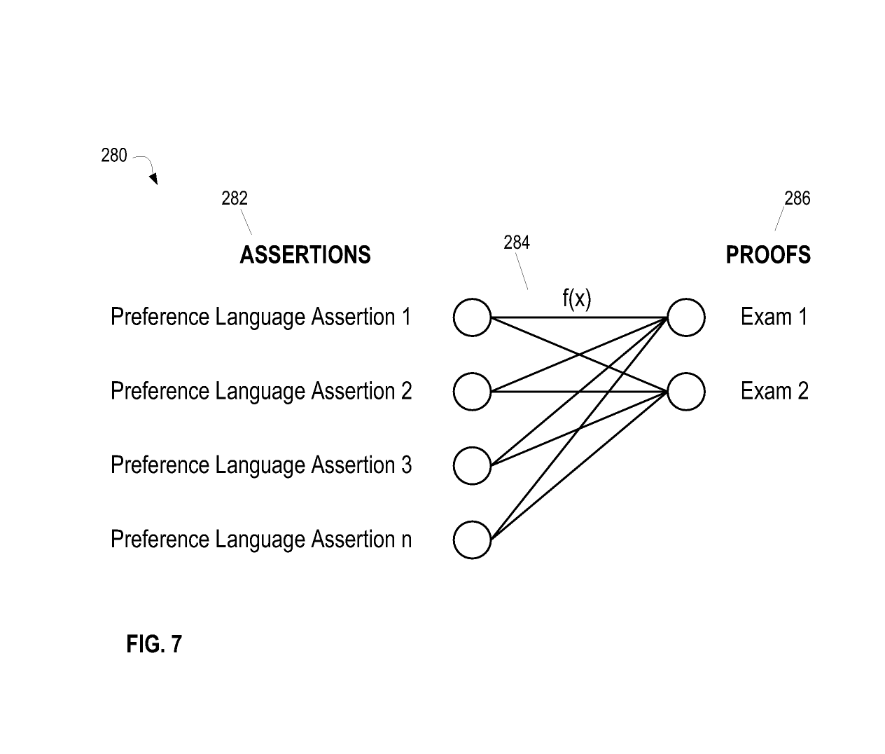

FIG. 1 is a diagrammatic view of a confidence rating system 10 of one implementation. In one implementation, confidence rating system 10 is part of a job position network that helps employers and candidates find each other. In another implementation, confidence rating system 10 is part of a company's web site or other system for helping fill open job positions within the company. Assertions 12 are provided to the confidence rating system 10 by employers. The term “assertions” as used herein is meant to include the job requirements that are specified by an employer for a particular job. Assertions can be provided for multiple jobs. In one implementation, an assertion language is used to allow the employers to specify the job requirements. The assertion language is described in further detail in FIGS. 4-5. These assertions 12 are then stored in a data store, such as a database or file server. Proofs 14 are provided to the confidence rating system 10 by or on behalf of candidates seeking jobs. The term “proofs” as used herein is meant to include a candidate's qualifications, such as resume of qualifications, school(s) attended, college transcript(s), certification transcript(s), and so on. The proofs 14 are also stored in a data store. Proofs can be provided by multiple candidates. A model of assertions 12 and proofs 14 is created, such as in the form of a bipartite graph. This is described in further detail in FIGS. 6-7.

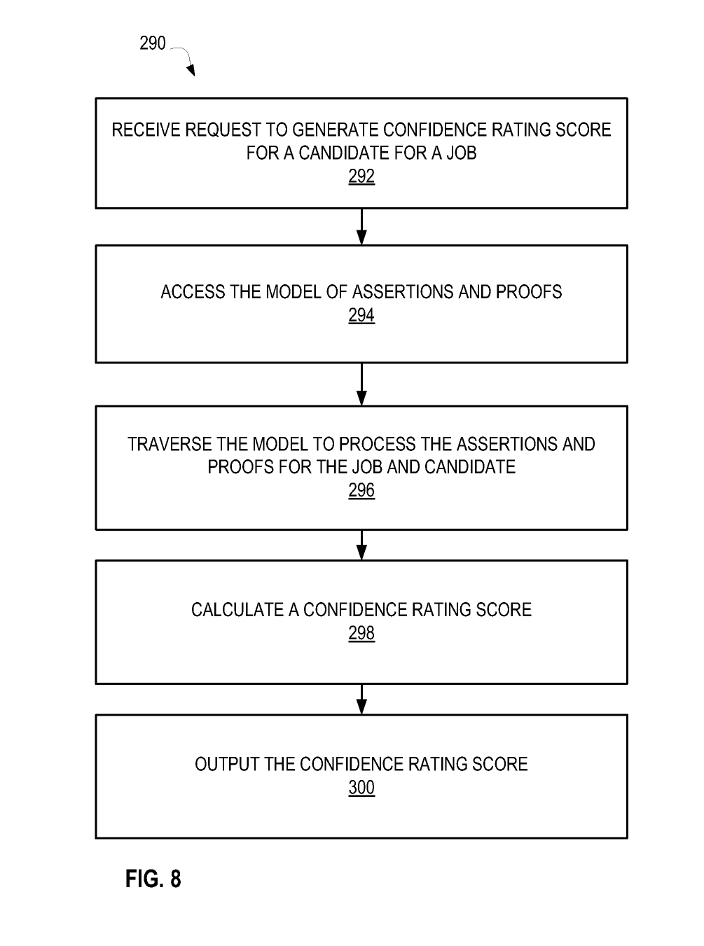

A score generation process 16 is initiated, such as upon request by an employer or a candidate, programmatically, as part of a scheduled process, and so on. The score generation process 16 then traverses the model of assertions and proofs and calculates a confidence rating score 18 for a candidate for a given job position, as described in more detail in FIG. 8. The term “confidence rating score” as used herein is meant to include an indicator or score of how well a candidate matches the skills required for a given job position. The confidence rating score can be a percentage, a scalar value (single number), letter grade, thumbs up/thumbs down, or any other indicator or value that can be used to determine how well a candidate's skills matches a given job position.

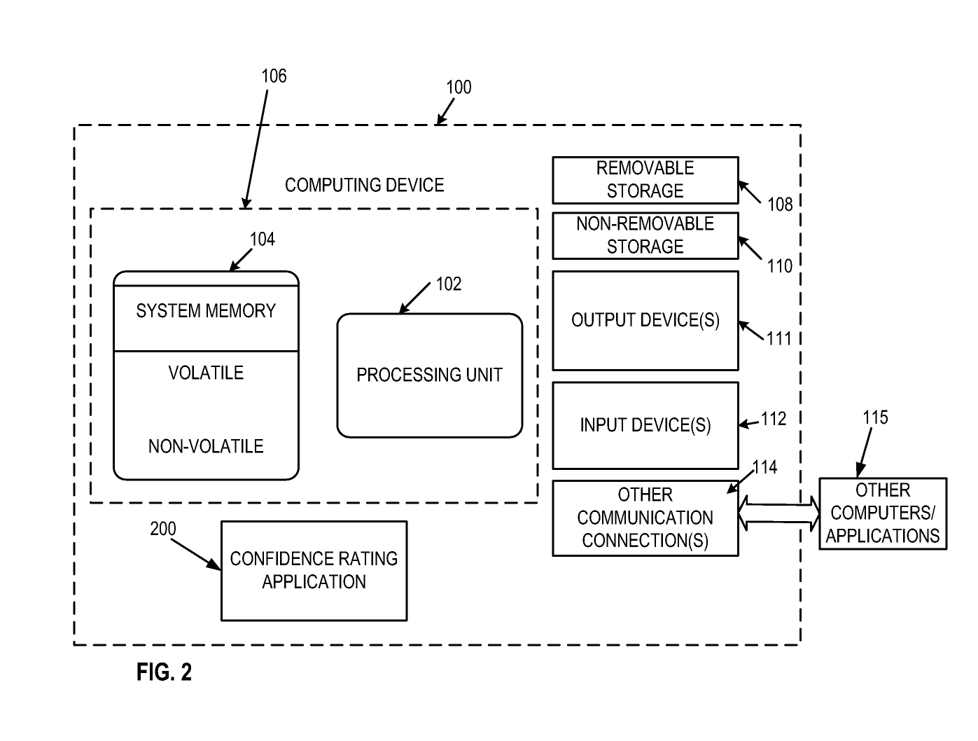

As shown in FIG. 2, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

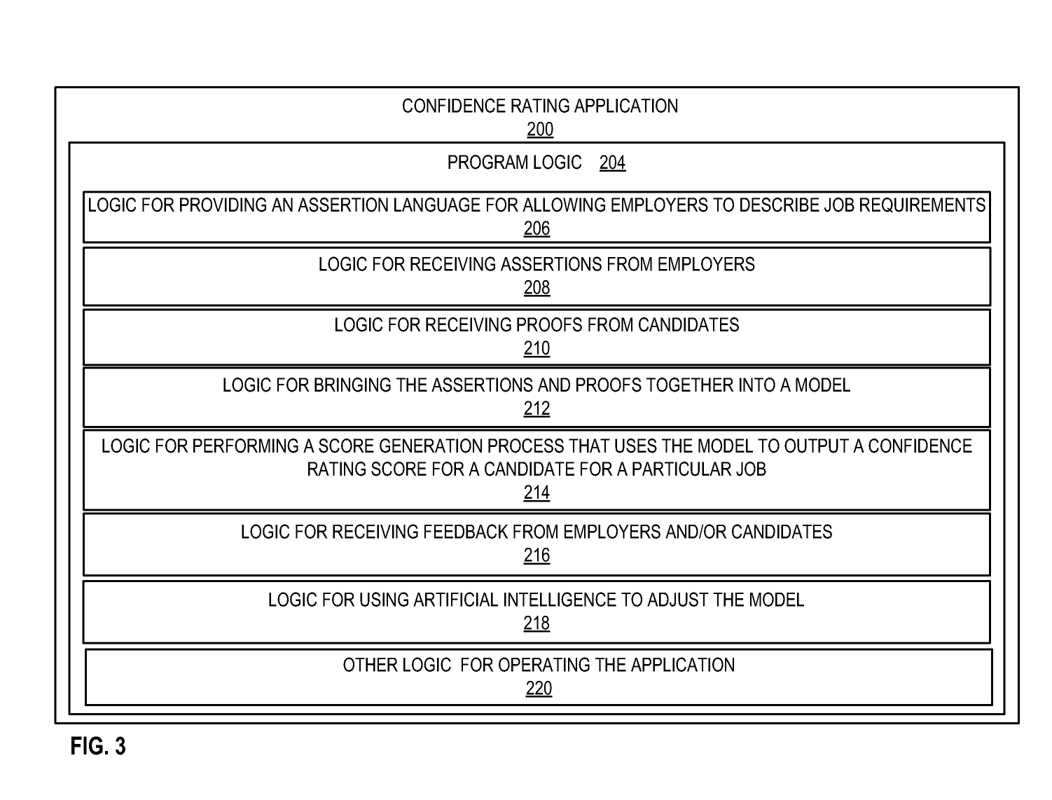

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes confidence rating application 200. Confidence rating application 200 will be described in further detail in FIG. 3.

Turning now to FIG. 3 with continued reference to FIG. 2, a confidence rating application 200 operating on computing device 100 is illustrated. Confidence rating application 200 is one of the application programs that reside on computing device 100. However, it will be understood that confidence rating application 200 can alternatively or additionally be embodied as computer-executable instructions on one or more computers and/or in different variations than shown on FIG. 2. Alternatively or additionally, one or more parts of confidence rating application 200 can be part of system memory 104, on other computers and/or applications 115, or other such variations as would occur to one in the computer software art.

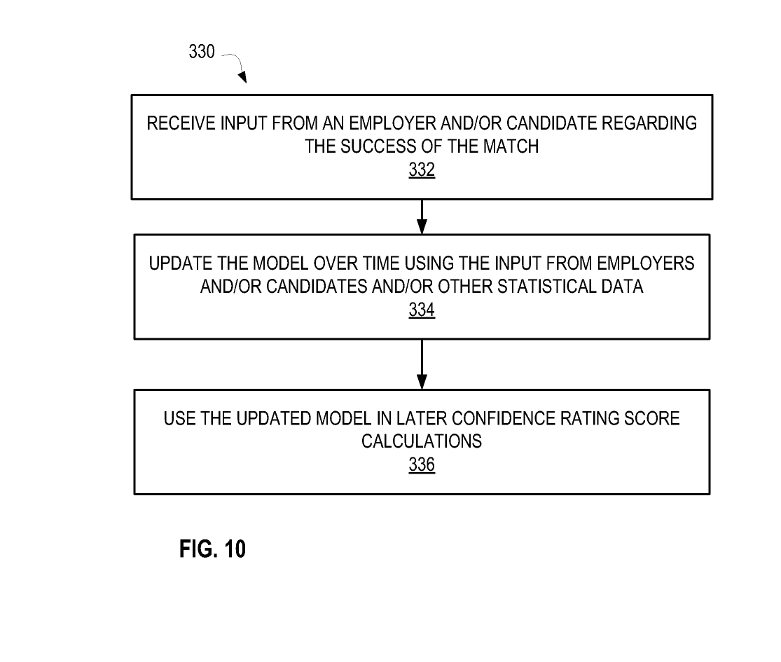

Confidence rating application 200 includes program logic 204, which is responsible for carrying out some or all of the techniques described herein. Program logic 204 includes logic for providing an assertion language for allowing employers to describe job requirements 206 (as described below with respect to FIG. 4-5); logic for receiving assertions from employers 208 (as described below with respect to FIG. 6); logic for receiving proofs from candidates 210 (as described below with respect to FIG. 6); logic for bringing the assertions and proofs together into a model 212 (as described below with respect to FIG. 6-7); logic for performing a score generation process that uses the model to output a confidence rating score for a candidate for a particular job 214 (as described below with respect to FIG. 8); logic for receiving feedback from employers and/or candidates 216 (as described below with respect to FIG. 10); logic for using artificial intelligence to adjust the model 218 (as described below with respect to FIG. 10); and other logic 220 for operating the confidence rating application 200.

Turning now to FIGS. 4-13 with continued reference to FIGS. 1-3, the stages for implementing one or more implementations of confidence rating application 200 are described in further detail. In some implementations, the processes of FIG. 4-13 are at least partially implemented in the operating logic of computing device 100. FIG. 4 is a diagrammatic view 230 of three dimensions contained in an assertion language syntax of one implementation. The assertion language syntax is a language syntax that can be used by employers to enter the assertions for describing the job requirements. In one implementation, the assertion language syntax is an eXtensible Markup Language (XML) syntax defined by a standard XML schema definition (XSD). Various other language styles can also be used that follow a pre-defined syntax. In the example shown, the assertion language syntax provides grammar for describing a skill 232, an object of the skill 234, and an environment 236. Examples of skills can include build, assemble, write, design, develop, test, etc. Examples of objects of the skill include tools or technologies used in performing the skill. Examples of environments include operating system environment, house, etc.

The discussion will now turn to FIG. 5 to further illustrate the assertion language syntax and the data elements that can be described using the grammar supported by the language syntax. The example in FIG. 5 indicates that “The individual being measured can do X on Y with Z.” In the example grammar, X (242) represents the skill (232 from FIG. 4), Y (244) represents the object of the skill (234 on FIG. 4), and Z (246) represents the environment (236 on FIG. 4). One example of how this sentence can be completed is also shown in the diagram, with a hypothetical skill 248, hypothetical object of the skill 250, and hypothetical environment 252 being specified. That completed example reads “The individual being measured can build web applications with Visual Studio 2005 on ASP.NET 2.0”.

Although three dimensions are shown in FIGS. 4 and 5, it should be understood that all three dimensions are not required in some implementations. At a minimum, the skill dimension should always be present. The more dimensions that are provided, the more specific the job position will be defined. In one implementation, the assertion language syntax is simple enough for a non-technical hiring manager to specify preferences for a position with the same degree or more confidence than he/she would have when looking at a resume. In another implementation, the language is expressive enough to allow for the creation of more focused, technically detailed job descriptions. Alternatively or additionally, the language enables weighted mappings to be applied to assertions inside the system. In yet another implementation, the language allows for the definition of new skills by the user community as those skills surface from the job market. In yet another implementation, the assertion language syntax is hidden from the user by a graphical user interface (GUI) which prompts the user to select or enter various options through a user interface that will help the user specify the job requirements.

FIG. 6 is a process flow diagram for one implementation illustrating the stages involved in bringing assertions and proofs together into a model. The system receives assertions from employers (stage 272), such as from multiple employers over a period of time as job positions are opened. The system then receives proofs from candidates (stage 274), such as from multiple candidates over a period of time as those candidates seek jobs. The proofs can be obtained directly from candidates, or from representatives of the candidates. For example, multiple certification proofs on a candidate can be automatically obtained from a certification management system from simply knowing the candidate's unique certification identifier. Similar information could be pulled in from university student record systems. The system brings the assertions and proofs together into a model (stage 276). The term “model” as used herein is meant to include the mathematical structure whereby assertions and proofs are organized so that they can be efficiently traversed and processed. The model can be created or updated periodically, depending on how frequently new assertions and proofs are being added. In one implementation, the model is regenerated each time new data is added to the confidence rating system 10. In another implementation, the model is regenerated on a scheduled period basis, such as daily. Numerous other variations are also possible for determining when to create the model.

In one implementation, the model is created as a bipartite graph (stage 276). The term “bipartite graph” as used herein is meant to include a graph whose vertices can be divided into two disjoint sets such that every edge connects a vertex in the first set and one in the second set; that is, there is no edge between two vertices in the same set. In another implementation, the model is created as a “complete bipartite graph”, which is a special kind of bipartite graph where every vertex of the first set is connected to every vertex of the second set.

An example bipartite graph 280 of assertions and proofs is shown in FIG. 7. Assertions 282 (as defined by the employers) and proofs 286 (as defined by candidates) are represented as a weighted complete bipartite graph. By applying a processing algorithm to traverse the relevant vertices 284 on the graph, the system 10 can generate a confidence rating score (predictor) of the candidate's success in the supplied position description. As described earlier, the confidence rating score can be in one of a variety of formats, such as a scalar value, percentage, or other values for representing how well the candidate matches the job. The generation of the confidence rating score will now be described in further detail in FIG. 8.

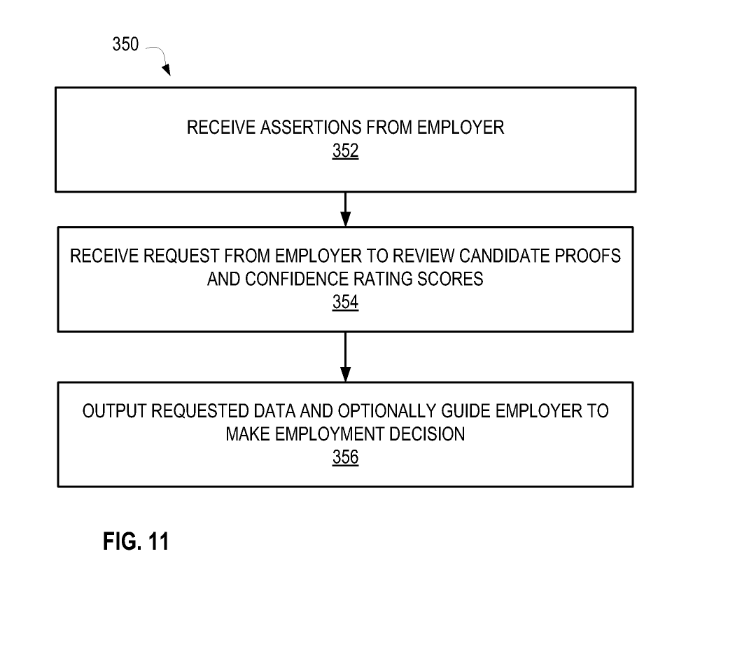

FIG. 8 is a process flow diagram 290 that illustrates one implementation of the stages involved in performing a score generation process to output a confidence rating score for a candidate for a particular job. The system receives a request to generate confidence rating score for a candidate for a job (stage 292). The model of assertions and proofs is accessed (stage 294). The bipartite graph (or other suitable graph or algorithm) is traversed to process the assertions and proofs for the job and candidate (stage 296). A confidence rating score is calculated based upon the traversal of the graph (stage 298). The confidence rating score is then output to an output device, or to another system (stage 300). For example, the confidence rating score can be displayed on a display device to an employer or candidate asking to see the score for a given position. As another example, the confidence rating score can be fed to another system that takes the score as input. In an alternate variation of the process of FIG. 8, multiple scores can be calculated for multiple candidates for a given position, such as to help an employer see a list of the various candidates having the highest confidence rating scores. In other words, this process can be performed in various combinations for single and/or multiple job positions and/or candidates. Some further examples of how the confidence rating score can be used are described in further detail in FIGS. 11-13.

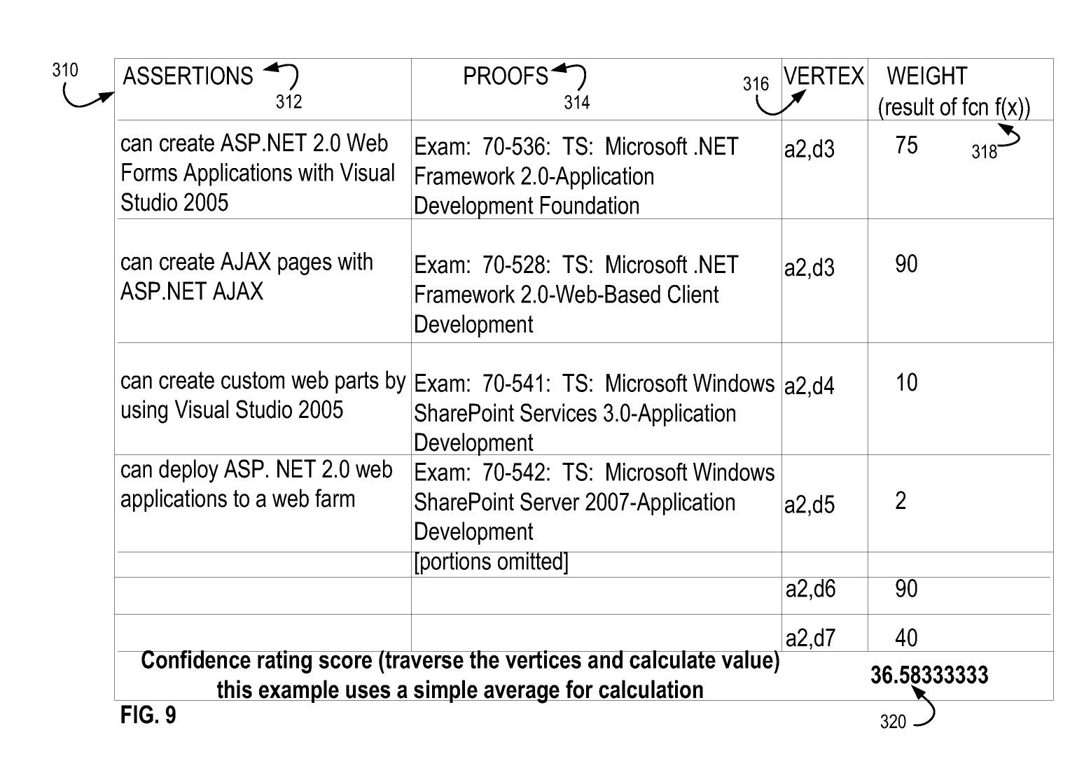

FIG. 9 is a simplified diagrammatic view 310 that illustrates how a confidence rating score is calculated using a bipartite graph for a hypothetical candidate based upon hypothetical assertions and proofs. In the example shown, the assertions 312 (job requirements of the employer) are shown in the first column. The proofs 314 (qualifications of the candidate) are shown in the second column. The vertex 316 is shown in the third column, and the weight 318 is shown in the fourth column. Some of the diagram was omitted for the sake of simplicity. The resulting confidence rating score 320 is then shown at the bottom based upon a aggregate function over the values in the diagram.

FIG. 10 is a process flow diagram 330 that illustrates one implementation of the stages involved in receiving feedback from employers and/or candidates and using artificial intelligence to adjust the model over time. Input is received from an employer and/or candidate regarding the success of the match (stage 332). In other words, after a candidate has been hired, the employer and/or candidate can give feedback that specifies how well the matching worked. The model is then updated over time using the input from employers and/or candidates and/or other statistical data (stage 334). For example, in the case of a complete bipartite graph, the vertex can be adjusted appropriately based upon the feedback and/or other statistical data. An example of statistical data that can be useful includes how long the candidate stayed at that job or how well the candidate was able to perform job functions related to a single assertion. The system uses the updated model in later analysis (stage 336). By changing the weights between assertions and proofs based on this sort of feedback, the confidence rating system 10 learns and becomes a more accurate predictor of a successful match over time.

Turning now to FIG. 11-13, some additional examples will be described for how the confidence rating score can be used by employers and candidates. FIG. 11 is a process flow diagram 350 that illustrates one implementation of the stages involved in allowing an employer to make an employment decision for a given job upon analyzing confidence rating scores. The system receives assertions from the employer (stage 352), such as when the employer sets up a new job position. At a later point in time, such as when the employer is seeking to fill open job positions, the system receives a request from an employer to review the candidates proofs and confidence rating scores (stage 354). In one implementation, the employer can enter search criteria to specify what job positions and/or what candidates the results should be displayed for. For example, the employer can enter a search request to see all of the candidates who may match a given job position, sorted in order by the confidence rating score of each candidate. As another example, the employer can select an option to view a confidence rating score for a selected candidate. Other variations are also possible. The system outputs the requested data and optionally guides the employer to make an employment decision (stage 356).

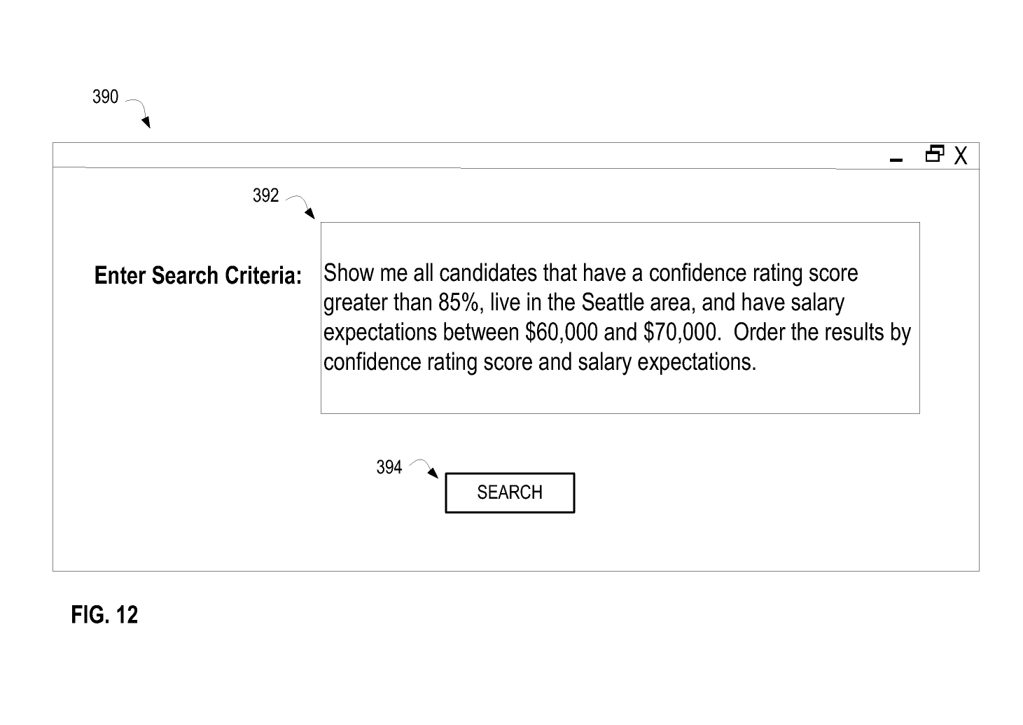

An example of an employer search is shown the simulated screen of FIG. 12. The simulated screen 390 contains an input field 392 that allows the employer to enter search criteria using the assertion language syntax described earlier. In the example shown, the search criteria is asking for all candidates that have a confidence rating score greater than 85% and live in Seattle, and that have salary expectations between $60,000 and $70,000. Order criteria are also specified to designate how the results should be ordered, which in this example is by confidence rating score and salary expectations. Upon entering the search criteria, the search can then be initiated upon selecting the search button 394. In other implementations, an assertion language syntax is not used, but instead, the employer is presented with drop-down menus or other mechanisms for selecting or entering the search criteria.

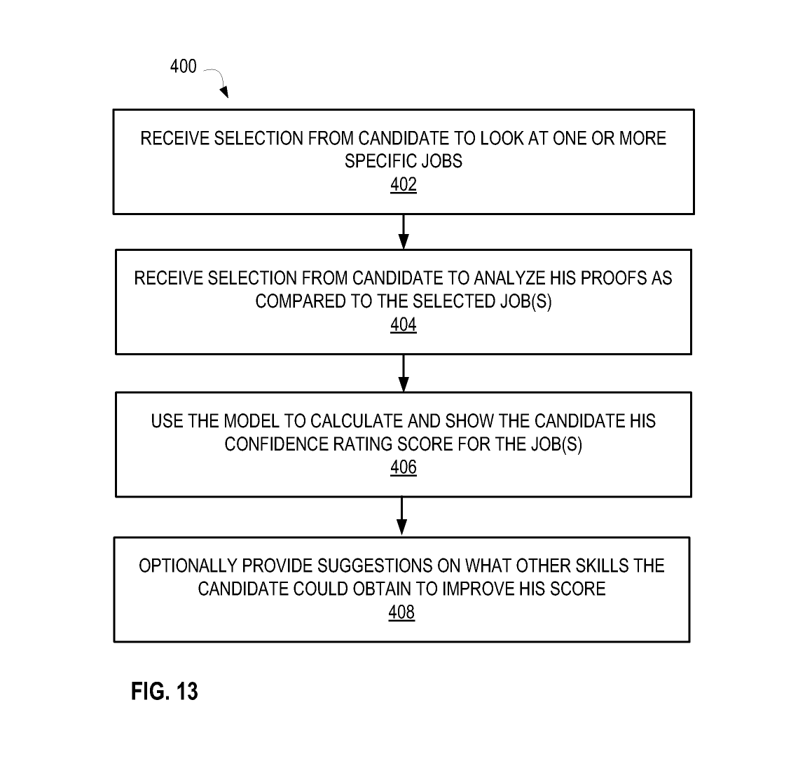

FIG. 13 is a process flow diagram 400 that illustrates one implementation of the stages involved in allowing a candidate to select one or more jobs and see how his skills compare to the selected jobs based on his confidence rating score for the given job. The system receives a selection from a candidate to look at one or more specific jobs (stage 402). The system receives a selection from a candidate to analyze his proofs as compared to the selected job(s) (stage 404). The system uses the model to calculate and show the candidate his confidence rating score for the job(s) (stage 406). The candidate is optionally provided with suggestions on what other sills the candidate could obtain to improve his score (stage 408). In other words, an optimum set of proofs that the candidate needs to obtain in order to have the highest probability of success in a described position can be displayed to the candidate. This data can be fed into training or other systems to help generate a custom learning plan for the candidate.

Subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
providing a language syntax that is operable to allow at least one assertion to be expressed, with the language syntax comprising grammar for representing a skill that is needed by a candidate for a specific job position, grammar for representing an object of the skill that is used to perform the skill, and grammar for representing an environment in which the skill is performed.

2. The computer-readable medium of claim 1, wherein the language syntax is a text-based format.

3. The computer-readable medium of claim 2, wherein the language syntax is structured in an XML format.

4. The computer-readable medium of claim 3, wherein the XML syntax is defined in an XSD schema.

5. The computer-readable medium of claim 1, wherein the skill is a required data element for the at least one assertion that is expressed using the language syntax.

6. The computer-readable medium of claim 1, wherein the object of the skill is an optional data element for the at least one assertion that is expressed using the language syntax.

7. The computer-readable medium of claim 1, wherein the environment is an optional data element for the at least one assertion that is expressed using the language syntax.

8. The computer-readable medium of claim 1, wherein the at least one assertion that is expressed using the language syntax is used in a score generation process for calculating a confidence rating score for one or more candidates.

9. A method for generating and using a model of assertions and proofs comprising the steps of:
receiving assertions from at least one employer, the assertions representing job requirements for one or more open job positions;
receiving proofs from at least one candidate, the proofs representing candidate qualifications; and
bringing assertions and proofs together into a model.

10. The method of claim 9, wherein the proofs include one or more transcripts of the at least one candidate.

11. The method of claim 9, further comprising:
using the model to generate a confidence rating score for a given candidate for a given job position.

12. The method of claim 11, wherein during the using step, a bipartite graph is traversed to help generate the confidence rating score for the given candidate.

13. The method of claim 11, further comprising:
outputting the confidence rating score for the given candidate.

14. The method of claim 13, wherein the confidence rating score is output to a display device.

15. The method of claim 13, wherein the confidence rating score is output to another system.

16. The method of claim 13, further comprising:
repeating the using and outputting steps for a plurality of candidates to generate a plurality of confidence rating scores.

17. The method of claim 16, wherein the plurality of confidence rating scores are displayed to an employer who is trying to locate possible matches for the one or more open job positions.

18. A method for providing a feedback process for improving a model of assertions and proofs over time comprising the steps of:
using a model of assertions and proofs to generate a confidence rating score for a candidate for a particular job;
after the candidate has been hired for the particular job, receiving input that indicates how well the confidence rating score represented an actual success of the candidate in performing the particular job;
updating the model of assertions and proofs based upon the input; and
using the updated model in later confidence rating score calculations.

19. The method of claim 18, wherein the updating the model step uses at least one other piece of data to help update the model.

20. The method of claim 19, wherein the at least one other piece of data includes how long the candidate stayed in the particular job.
